(19) United States
(12) Patent Application Publication
(10) Pub. No.: US 2012/0188401 A1
(43) Pub. Date: Jul. 26, 2012

(54) IMAGE PROCESSING APPARATUS

(75) Inventor: Koji TAKEMOTO, Izuminsano-shi (JP)

(73) Assignee: SANYO ELECTRIC CO., LTD., Osaka (JP)

(21) Appl. No.: 13/355,518

(22) Filed: Jan. 21, 2012

(30) Foreign Application Priority Data
Jan. 21, 2011 (JP) 2011-11130

(51) Int. Cl. H04N 9/73

(52) U.S. Cl. 348/223.1; 348/E09.051

(57) ABSTRACT

An image processing apparatus includes a taker which repeatedly takes an image expressing an imaged scene. An adjuster adjusts a white balance of the taken image, referring to a confirmed white balance adjustment coefficient. A calculator calculates an appropriate white balance adjustment coefficient based on a partial image indicating colors in a color range that includes a white color, out of the taken image. A detector detects a possibility of the partial image focused on by the calculator being an image expressing a human skin, based on the calculated appropriate white balance adjustment coefficient. A corrector brings a value of the calculated appropriate white balance adjustment coefficient closer to a value of the confirmed white balance adjustment coefficient, along with an increase in the value of the detected possibility. An updater updates the confirmed white balance adjustment coefficient by the appropriate white balance adjustment coefficient indicating the corrected value.

### CROSS REFERENCE OF RELATED APPLICATION

The disclosure of Japanese Patent Application No. 2011-11130, which was filed on Jan. 21, 2011, is incorporated herein by reference.

### BACKGROUND OF THE INVENTION

1. Field of the Invention

The present invention relates to an image processing apparatus, and in particular, relates to an image processing apparatus which is applied to a video camera and adjusts a white balance of a subject image.

2. Description of the Related Art

In one example of such type of apparatus, an image that is imaged is divided into a plurality of blocks, and a color evaluation value is obtained for every block. A white balance correction value is calculated based on the obtained color evaluation value, and an ambient light source is presumed based on the same color evaluation value. When a facial region is detected from the image, the above-described white balance correction value is applied to the block corresponding to the facial region, and a skin color evaluation value is obtained. When the obtained skin color evaluation value is included in the skin color region corresponding to the presumed ambient light source, the above-described white balance correction value is decided as a final white balance correction value. Due to this, the accuracy of white balance control is improved.

However, in the above-described apparatus, as high-precision white balance control in situations where a facial region is not detected is not assumed, there is a limit to the performance of white balance adjustment

### SUMMARY OF THE INVENTION

An image processing apparatus according to the present invention comprises: a taker which repeatedly takes an image that expresses an imaged scene; an adjuster which adjusts a white balance of the image taken by the taker with reference to a confirmed white balance adjustment coefficient; a calculator which calculates an appropriate white balance adjustment coefficient based on a partial image indicating colors in a color range that includes a white color, out of the image taken by the taker; a detector which detects a possibility that the partial image focused on by the calculator is an image expressing a human skin, based on the appropriate white balance adjustment coefficient calculated by the calculator; a corrector which brings a value of the appropriate white balance adjustment coefficient calculated by the calculator closer to a value of the confirmed white balance adjustment coefficient, along with an increase of the value of the possibility detected by the detector; and an updater which updates the confirmed white balance adjustment coefficient by the appropriate white balance adjustment coefficient which indicates the value corrected by the corrector.

According to the present invention, a white balance adjustment program recorded on a non-transitory recording medium in order to control an image processing apparatus provided with a taker which repeatedly takes an image that expresses an imaged scene and an adjustor which adjusts a white balance of the image taken by the taker with reference to a confirmed white balance adjustment coefficient, the program causing a processor of the image processing apparatus to perform the steps comprises: a calculation step of calculating the appropriate white balance adjustment coefficient based on a partial image indicating colors in a color range including the white color, out of the image taken by the taker; a detection step of detecting a possibility that the partial image focused on by the calculation step is an image expressing a human skin, based on the appropriate white balance adjustment coefficient calculated by the calculation step; a correction step of bringing a value of the appropriate white balance adjustment coefficient, calculated by the calculation step, closer to the value of the confirmed white balance adjustment coefficient, along with an increase of a value of the possibility detected by the detection step; and an updating step of updating the confirmed white balance adjustment coefficient by the appropriate white balance adjustment coefficient showing the value corrected by the correction step.

According to the present invention, a white balance adjustment method executed by an image processing apparatus provided with a taker which repeatedly takes a subject image and an adjustor which adjusts a white balance of the subject image taken by the taker with reference to a confirmed white balance adjustment coefficient, the image processing apparatus being caused to perform the steps comprises: a calculation step of calculating an appropriate white balance adjustment coefficient based on a partial image indicating colors in a color range including a white color, out of the subject image taken by the taker; a detection step of detecting a possibility that the partial image focused on by the calculation step is an image expressing a human skin, based on the appropriate white balance adjustment coefficient calculated by the calculation step; a correction step of bringing a value of the appropriate white balance adjustment coefficient, calculated by the calculation step, closer to the value of the confirmed white balance adjustment coefficient, along with an increase of a value of the possibility detected by the detection step; and an updating step of updating the confirmed white balance adjustment coefficient by the appropriate white balance adjustment coefficient showing the value corrected by the correction step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative diagram showing one example of an assignment of evaluation areas in an imaging surface;

FIG. 4 is a block diagram showing one example of a configuration of a post-processing circuit applied to the embodiment in FIG. 2;

FIG. 5 is an illustrative diagram showing one example of an assignment of a plurality of white detection areas different for each light source;

FIG. 6 is a graph showing one example of a relation between a distance from coordinates (αs, βs) to coordinates (αskin, βskin) and a possibility of a human skin;

FIG. 7 is a graph showing one example of a relation between a possibility of a human skin and each of correction values of optimum gains αs and βs;

FIG. 8(A) is an illustrative diagram showing one portion of a white balance adjustment process;

FIG. 8(B) is an illustrative diagram showing another portion of the white balance adjustment process;

FIG. 9 is a timing chart showing the other parts of the white balance adjustment process;

FIG. 10 is a flow chart showing one portion of an operation of a CPU applied to the embodiment in FIG. 2;

FIG. 11 is a flow chart showing another portion of the operation of the CPU applied to the embodiment in FIG. 2;

FIG. 12 is a flow chart showing still another portion of the operation of the CPU applied to the embodiment in FIG. 2;

FIG. 13 is a flow chart showing yet another portion of the operation of the CPU applied to the embodiment in FIG. 2;

FIG. 14 is a flow chart showing another portion of the operation of the CPU applied to the embodiment in FIG. 2; and

FIG. 15 is a block diagram showing a configuration of another embodiment of the present invention.

### DETAILED DESCRIPTION OF THE PREFERRED EMBODIMENTS

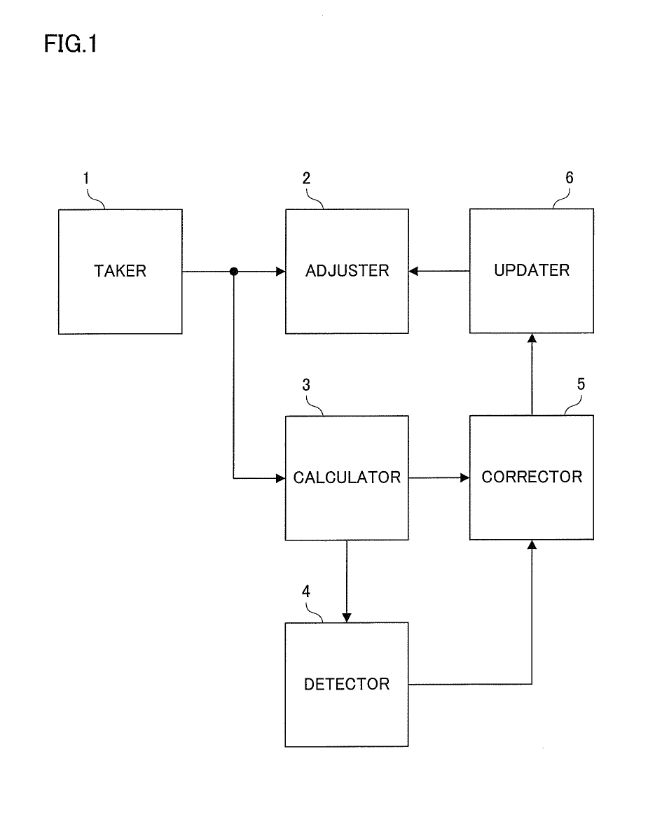

With reference to FIG. 1, a video camera according to one embodiment of the present invention is basically configured in the following manner. A taker 1 repeatedly takes an image that expresses an imaged scene. An adjuster 2 adjusts a white balance of the image taken by the taker 1, referring to a confirmed white balance adjustment coefficient. A calculator 3 calculates an appropriate white balance adjustment coefficient based on a partial image, which indicates colors in a color range that includes a white color, out of the image taken by the taker 1. A detector 4 detects a possibility of the partial image focused on by the calculator 3 being an image expressing a human skin, based on the appropriate white balance adjustment coefficient calculated by the calculator 3. A corrector 5 brings a value of the appropriate white balance adjustment coefficient calculated by the calculator 3 closer to a value of the confirmed white balance adjustment coefficient, along with an increase in the value of the possibility detected by the detector 4. An updater 6 updates the confirmed white balance adjustment coefficient by the appropriate white balance adjustment coefficient which displays the value corrected by the corrector 5.

The appropriate white balance adjustment coefficient is calculated based on the partial image which indicates the color belonging to the color range indicating the white color, and the possibility of the partial image being an image which expresses a human skin is detected based on the calculated appropriate white balance adjustment coefficient. The value of the appropriate white balance adjustment coefficient is brought closer to the value of the confirmed white balance adjustment coefficient as the value of the detected possibility increases. The confirmed white balance adjustment coefficient is updated by thus corrected appropriate white balance adjustment coefficient, and the white balance of the object image repeatedly taken is adjusted with reference to the updated confirmed white balance adjustment coefficient. Due to this, fluctuations in the white balance caused by the appearance of a human skin can be suppressed, and the performance of white balance adjustment is improved.

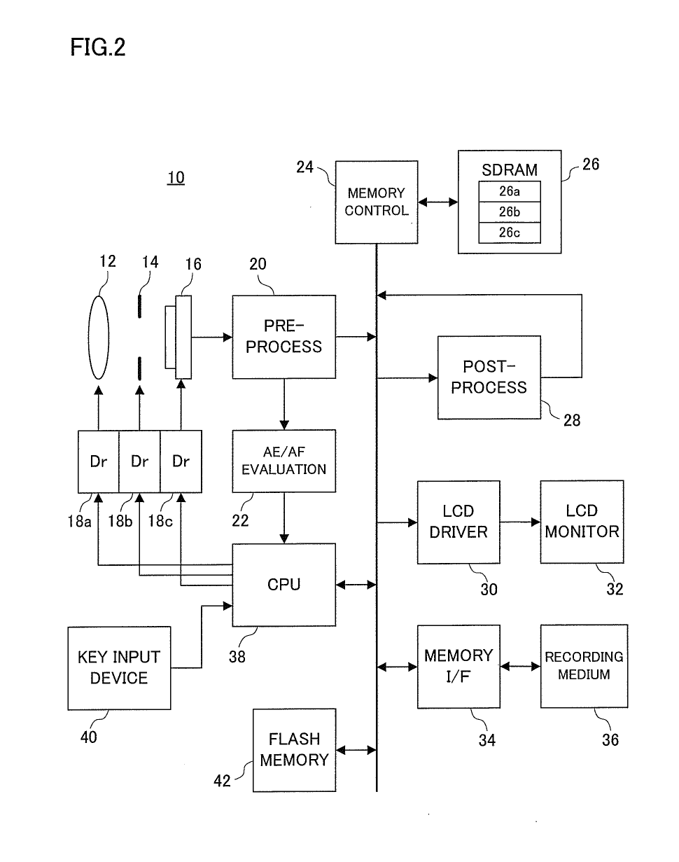

With reference to FIG. 2, a digital video camera 10 of this embodiment includes a focus lens 12 and an aperture mechanism 14, which are driven by drivers 18a and 18b, respectively. An optical image representing a scene enters, with irradiation, an imaging surface of the image sensor 16 through these members.

On the imaging surface, a plurality of light-receiving elements (=pixels) are arranged 2-dimensionally, and the imaging surface is covered by a color filter (not shown) of a primary color Bayer pattern. The light-receiving elements arranged on the imaging surface correspond one to one with filter elements which configure the color filter, and an amount of electric charges generated by each light-receiving element reflects the strength of light corresponding to R (Red), G (Green), or B (Blue).

When a power source is turned on, a CPU 38 activates the driver 18c under an imaging control task, in order to execute a moving image taking process. In response to a vertical synchronization signal Vsync generated at every 1/60 second, the driver 18c exposes the imaging surface, and reads out the electric charges generated thereby from the imaging surface in a raster scanning manner. As a result of this, raw image data expressing the scene is outputted from the image sensor 16 at a frame rate of 60 fps. The outputted raw image data corresponds to image data where each pixel has color information of any one of R, G, and B.

A pre-processing circuit 20 performs processes such as digital clamping, pixel defect correction, and gain control, on the raw image data outputted from the image sensor 16. The raw image data on which such a pre-process has been performed is written into a raw image area 26a of an SDRAM 26, through a memory control circuit 24. A post-processing circuit 28 reads out the raw image data housed in the raw image area 26a at every 1/60 second through the memory control circuit 24, and performs processes, such as color separation, white balance adjustment, and YUV conversion, on the read-out raw image data. The image data in a YUV format generated thereby is written into a YUV image area 26b of the SDRAM 26, through the memory control circuit 24.

An LCD driver 30 repeatedly reads out the image data housed in the YUV image area 26b through the memory control circuit 24, and drives an LCD monitor 32 based on the read-out image data As a result of this, a real-time moving image (through image) expressing the scene is displayed on the monitor screen.

When a recording start manipulation is performed on a key input device 40, the CPU 38 applies a corresponding command to a memory I/F 34, in order to start a recording process. The memory I/F 34 repeatedly reads out the image data housed in the YUV image area 26b, and saves the read-out image data on a recording medium 36. When a recording end manipulation is performed on the key input device 40, the CPU 38 applies a corresponding command to a memory I/F 34, in order to end the recording process. The memory I/F 34 ends the above-described operation.

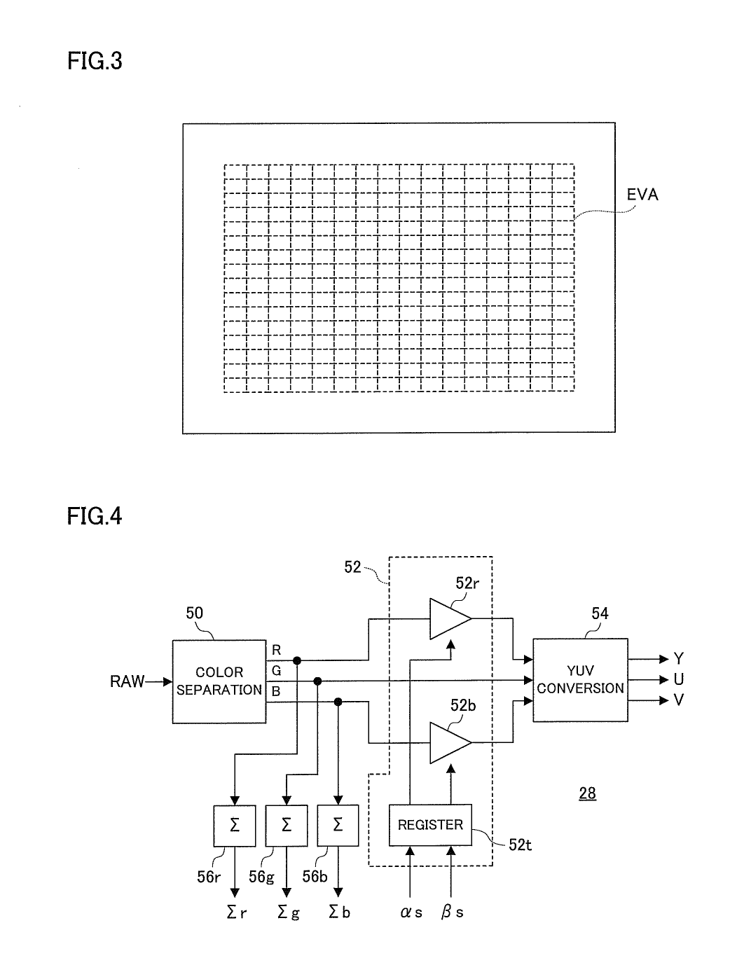

With reference to FIG. 3, an evaluation area EVA is assigned to the imaging surface. The evaluation area EVA is divided into 16 parts in each of a horizontal direction and a vertical direction, and a total of 256 divided areas are arranged on the imaging surface in a matrix. The pre-processing circuit 20 converts one portion of the raw image data belonging to the evaluation area EVA simply into Y data, and applies the converted Y data to an AE/AF evaluation circuit 22.

The AE/AF evaluation circuit 22 integrates the applied Y data for each divided area, and creates a total of 256 integral values as luminance evaluation values. The AE/AF evaluation circuit 22 also integrates a high frequency component of the applied Y data for each divided area, and creates a total of 256 integral values as AF evaluation values. These integral processes are repeatedly executed every time the vertical synchronization signal Vsync is generated. As a result of this, 256 luminance evaluation values and 256 AF evaluation values are outputted, in response to the vertical synchronization signal Vsync, from the AE/AF evaluation circuit 22.

Imaging conditions are adjusted in the following manner, every time the vertical synchronization signal Vsync is generated. Also, the following processes are, under the imaging condition adjustment task parallel with the imaging control task, executed by the CPU 38.

First, an AE process is executed in reference to the 256 luminance evaluation values outputted from the AE/AF evaluation circuit 22. Thereby, an appropriate EV value is calculated, and an aperture amount and an exposure time which define the calculated appropriate EV value are set to the drivers 18b and 18c, respectively. As a result of this, a brightness of the through image is moderately adjusted. Next, whether or not a predetermined AF activation condition is satisfied is determined based on the 256 AF evaluation values outputted from the AE/AF evaluation circuit 22. The AF process is suspended in correspondence to a negative determined result, and executed in correspondence to a positive determined result. The focus lens 12 is arranged at a focal point by the AF process, and thereby, a sharpness of the through image is improved.

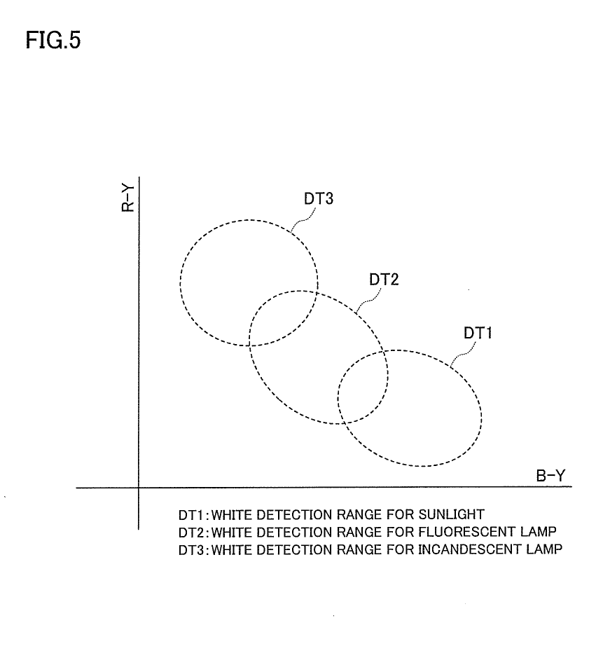

The post-processing circuit 28 is configured as shown in FIG. 4. As described above, the raw image data corresponds to image data where each pixel has color information of any one of R, G, and B. A color separation circuit 50 converts the raw image data into image data where each pixel has color information of all R, G, and B. The converted image data is applied to a white balance adjustment circuit 52.

Set to a resistor 52t are optimum gains αs and βs for adjusting the white balance. Out of these, the optimum gain αs is applied to an amplifier 52r, and the optimum gain βs is applied to an amplifier 52b. R color information which forms the image data converted by the color separation circuit 50, that is, the R data, is amplified by the amplifier 52r, and B color information which forms the same image data, that is, the B data, is amplified by the amplifier 52b. In such a way, image data with an adjusted white balance is obtained.

A format of the image data having the adjusted white balance is converted from an RGB format to a YUV format by a YUV conversion circuit 54. The converted image data is outputted towards the memory control circuit 24.

Also, out of the image data converted by the color separation circuit 50, the R data is applied to an integrator 56r, the B data is applied to an integrator 56b, and the G color information, that is, the G data, is applied to an integrator 56g. The integrators 56r, 56g, and 56b respectively integrate the applied R data, G data, and B data for each divided area forming the evaluation area EVA shown in FIG. 3. This integration process is also repeatedly executed every time the vertical synchronization signal Vsync is generated. As a result of this, 256 R evaluation values Σr; Σr, . . . are outputted from the integrator 56r in response to the vertical synchronization signal Vsync, 256 G evaluation values Σg, Σg, . . . are outputted from the integrator 56g in response to the vertical synchronization signal Vsync, and 256 B evaluation values Σb, Σb, . . . are outputted from the integrator 56b in response to the vertical synchronization signal Vsync.

Also under the imaging condition adjustment task, an AWB process is repeatedly executed in reference to the acquired R evaluation value Σr, G evaluation value Σg, and B evaluation value Σb, in response to the vertical synchronization signal Vsync. The optimum gains αs and βs set to the resistor 52t are repeatedly updated by the AWB process, and as a result of this, the white balance of the through image is continuously adjusted.

Specifically, the AWB process is executed in the following manner. First, total sums SUMΣr, SUMΣg, and SUMΣb are set to “0”. Next, the 256 R evaluation values Σr, Σr, . . . are taken from the integrator 56r, the 256 G evaluation values Σg, Σg, . . . are taken from the integrator 56g, and the 256 B evaluation values Σb, Σb, . . . are taken from the integrator 56b.

Following this, a variable K is set to each of “1” to “256”, and it is determined whether or not the color defined by the R evaluation value Σr, the G evaluation value Σg, and the B evaluation value Σb corresponding to a K-th divided area belongs to at least one of the white detection ranges DT1 to DT3 shown in FIG. 5. Then, if the determined result is positive, the K-th R evaluation value Σr is added to the total sum SUMΣr, the K-th G evaluation value Σg is added to the total sum SUMΣg, and the K-th B evaluation value Σb is added to the total sum SUMΣb.

In FIG. 5, the white detection range DT1 is equivalent to a range that covers colors near the color of an object image expressing a white colored object with which sunlight is irradiated. Also, the white detection range DT2 is equivalent to a range that covers colors near the color of an object image expressing a white colored object with which light from a fluorescent lamp is irradiated. Furthermore, the white detection range DT3 is equivalent to a range that covers colors near the color of an object image expressing a white colored object with which light from an incandescent lamp is irradiated.

The total sum SUMΣr is equivalent to the total sum of the R evaluation values Σr, Σr, . . . belonging to at least one of the white detection ranges DT1 through DT3. Similarly, the total sum SUMΣg is equivalent to the total sum of the G evaluation values Σg, Σg, . . . belonging to the white detection ranges DT1 through DT3, and the total sum SUMΣb is equivalent to the total sum of the B evaluation values Σb, Σb, . . . belonging to the white detection ranges DT1 through DT3.

The optimum gains αs and βs are calculated by applying thus obtained total sums SUMΣr, SUMΣg, and SUMΣb to Equation 1. The calculated optimum gains αs and βs are equivalent to gains for converting a color, which is obtained by mixing colors belonging to at least one of the white detection ranges DT1 through DT3 by an additive color process, into the white color.

αs=SUMΣg/SUMΣr

βs=SUMΣg/SUMΣb [Equation 1]

An arithmetic process according to the Equation 1 is repeatedly executed in response to the vertical synchronization signal Vsync. When the first arithmetic process is completed, the skin color gains αskin and βskin are initialized based on the calculated optimum gains αs and βs. The skin color gain αskin shows a value which is K1 times the optimum gain αs, and the skin color gain βskin shows a value which is K2 times the optimum gain βs. Here, each of “K1” and “K2” is a constant. Also, the skin color gains αskin and βskin are equivalent to gains for converting the skin color to the white color.

When initialization of the skin color gains αskin and βskin is completed, the optimum gains αs and βs calculated according to the Equation 1 are set to the resistor 52t. Furthermore, the same optimum gains αs and βs are withdrawn as backup gains αbk and βbk. The backup gains αbk and βbk at all times match the optimum gains αs and βs set to the resistor 52t, respectively.

After second and further arithmetic processes according to the Equation 1, there is executed a process of calculating a possibility that the object, having a color belonging to at least one of the white detection ranges DT1 through DT3, is the human skin as “L”. The possibility L is calculated in the following manner.

First, an absolute value of the difference between the skin color gain αskin and the optimum gain αs is calculated as “Δα”, and an absolute value of the difference between the skin color gain βskin and the optimum gain βs is calculated as “Δβ”. Next, “D” showing the distance between the coordinates (αskin, βskin) and the coordinates (αs, βs) is calculated according to Equation 2.

D=√(Δα²+Δβ²) [Equation 2]

If the calculated distance D exceeds the maximum value Dmax, the possibility L is set to “0”. Also, if the calculated distance D falls below the minimum value Dmin, the possibility L is set to “Lmax”. Furthermore, if the calculated distance D is equal to or less than the maximum value Dmax yet equal to or greater than the minimum value Dmin, the possibility L is calculated according to Equation 3.

L={1−(D−Dmin)/(Dmax−Dmin)}/100 [Equation 3]

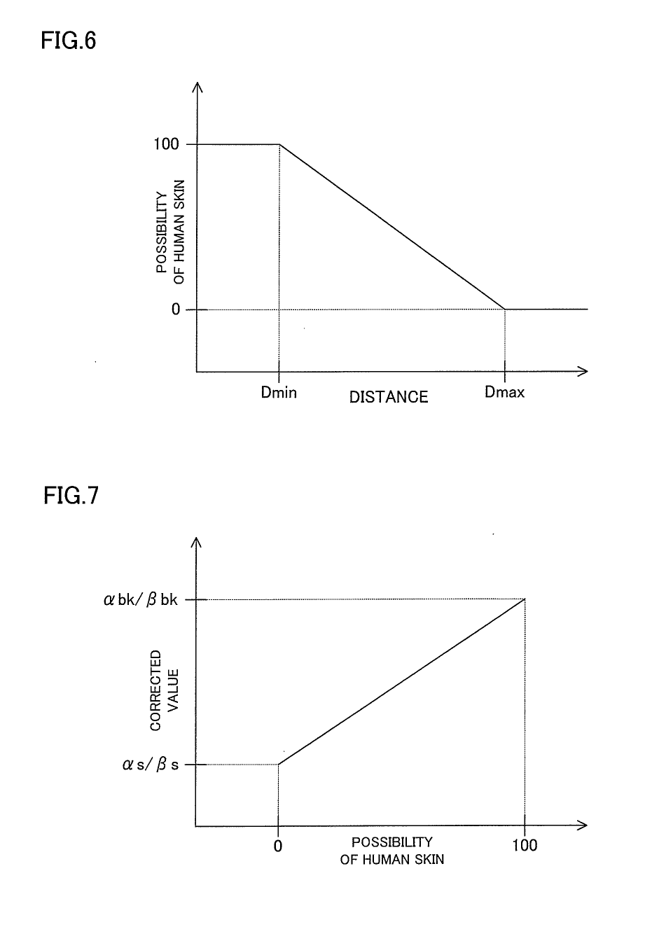

Accordingly, the possibility L shows a characteristic, shown in FIG. 6, in relation to the distance D. According to FIG. 6, the possibility L shows “100” in a range where the distance D falls below the minimum value Dmin, decreases to “0” as the distance D increases from the minimum value Dmin, and maintains “0” in a range where the distance D exceeds the maximum value Dmax.

When the calculated possibility L exceeds “0”, the optimum gains αs and βs are corrected according to Equation 4.

αs={L*αbk+(Lmax−L)*αs}/Lmax

βs={L*βbk+(Lmax−L)*βs}/Lmax [Equation 4]

The corrected values of the optimum gains αs and βs show a characteristic, shown in FIG. 7, in relation to the possibility L. In other words, the corrected values of the optimum gains αs and βs come closer to the backup gains αbk and βbk as the possibility L increases. The optimum gains αs and βs as well as the backup gains αbk and βbk set to the resistor 52t are in this way updated by the corrected optimum gains αs and βs. Accordingly, when a human skin appears on the scene, the variation of the optimum gains αs and βs set to the resistor 52t is suppressed.

On the other hand, when the calculated possibility L is “0”, in place of the correction process of the optimum gains αs and βs according to the Equation 4, an updating process of the skin color gains αskin and βskin is executed. Similar to the above, the skin color gain αskin is set to K1 times the optimum gain αs calculated according to the Equation 1, and the skin color gain βskin is set to K2 times the optimum gain βs calculated according to the Equation 1. Also, the optimum gains αs and βs as well as the backup gains αbk and βbk set to the resistor 52t are updated by the optimum gains αs and βs calculated according to the Equation 1.

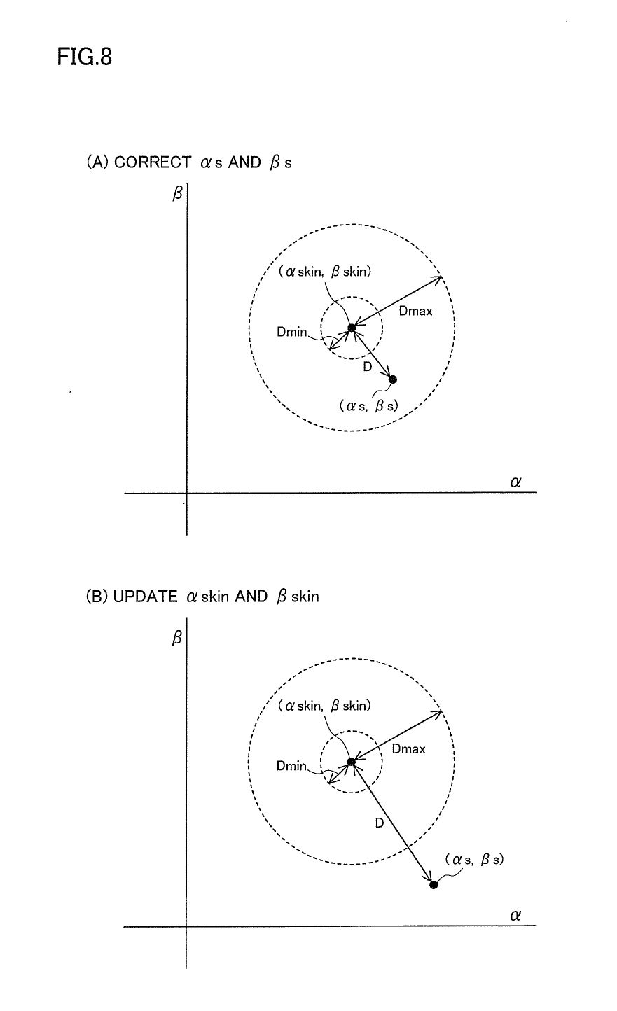

In other words, when the coordinates (αskin, βskin) and (αs, βs) are in a positional relationship shown in FIG. 8(A) (=when the distance D is eqi ial to or less than the maximum value Dmax), the optimum gains αs and βs are corrected according to the Equation 4. In addition, the optimum gains αs and βs after correction are set to the resistor 52t, and withdrawn as the backup gains αbk and βbk.

Contrary to this, when the coordinates (αskin, βskin) and (αs, βs) are in a positional relationship shown in FIG. 8(B) (=when the distance D exceeds the maximum value Dmax), the skin color gains αskin and βskin are updated based on the optimum gains βs and βs calculated according to the Equation 1. Besides, the optimum gains αs and βs calculated according to the Equation 1, are set to the resistor 52t, and withdrawn as the backup gains αbk and βbk.

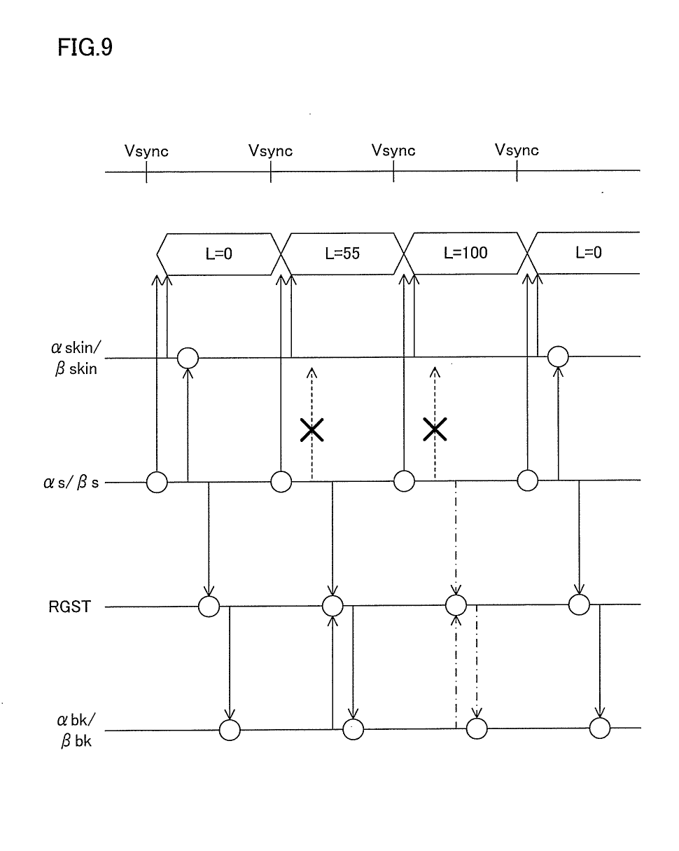

When the possibility L changes in a manner shown in FIG. 9, the skin color gains αskin and βskin, the optimum gains αs and βs, the setting of the resistor 52t, and the backup gains αbk and βbk are updated in the following manner.

If the calculated possibility L is “0”, the skin color gains αskin and βskin are updated based on the optimum gains αs and βs calculated according to the Equation 1. Furthermore, the optimum gains αs and βs calculated according to the Equation 1 are set to the resistor 52t, and withdrawn as the backup gains αbk and βbk.

If the calculated possibility L is “55”, the updating of the skin color gains αskin and βskin is suspended. The values of the optimum gains αs and βs are corrected with reference to the values of the backup gains αbk and βbk, and the corrected optimum gains αs and βs are set to the resistor 52t. The backup gains αbk and βbk are updated by the corrected optimum gains αs and βs.

Furthermore, when the calculated possibility L shows “100”, processes similar to when the possibility L is “55” are executed. However, as can been seen from the Equation 4, when the possibility L shows “100”, the corrected values of the optimum gains αs and βs match the values of the backup gains αbk and βbk. For this reason, the processes of setting the corrected optimum gains αs and βs to the resistor 52t and withdrawing them as the backup gains αbk and βbk are substantially meaningless.

In this way, by bringing the values of the optimum gains αs and βs closer to the values of the backup gains αbk and βbk when the human skin appears, it is possible to suppress variations in the white balance caused by the appearance of the human skin. Also, by updating the skin color gains αskin and βskin when the possibility L is “0”, it is possible to prevent the lowering in the precision of the calculation, of the possibility L caused by changes in the light source.

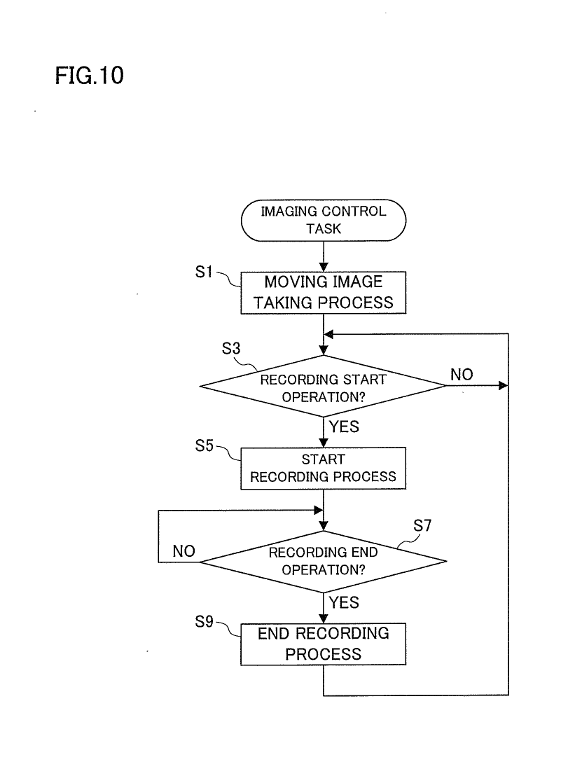

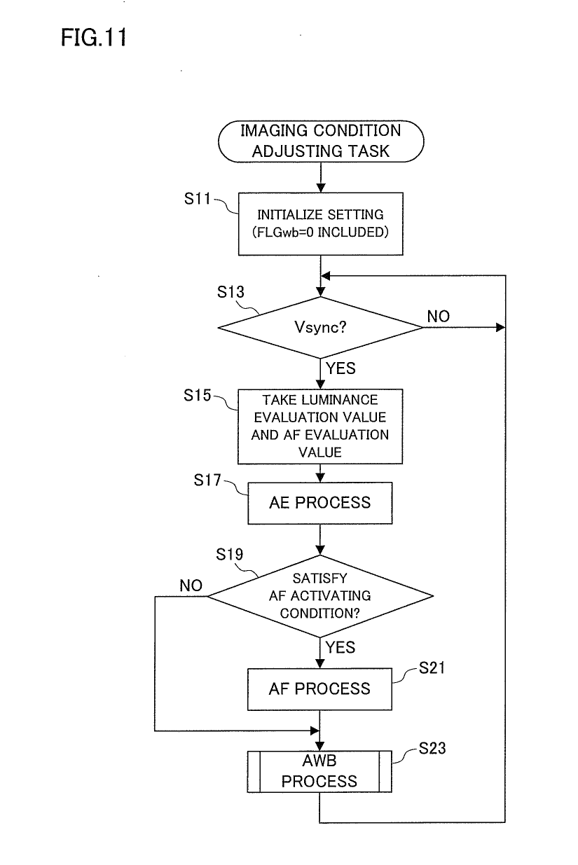

The CPU 38 executes a plurality of tasks, including the imaging control task shown in FIG. 10 and the imaging condition adjustment task shown in FIG. 11 through FIG. 14, in parallel under the control of a multi-task OS. Furthermore, a control program corresponding to these tasks is stored on a flash memory 42.

With reference to FIG. 10, in a step S1, the moving image taking process is executed. As a result, the through image is displayed on the LCD monitor 32. In a step S3, it is determined whether or not the recording start manipulation has been performed, and when the determined result is updated from NO to YES, the process proceeds to a step S5. In the step S5, to start the recording process, a corresponding command is applied to the memory I/F 34. The memory I/F 34 repeatedly reads out the image data housed in the YUV image area 26b through the memory control circuit 24, and saves the read-out image data onto the recoding medium 36. In a step S7, it is determined whether or not the recording end manipulation has been performed, and when the determined result is updated from NO to YES, the process proceeds to a step S9. In the step S9, to end the recording process, a corresponding command is applied to the memory I/F 34. The memory I/F 34 ends the above-described operation. When the process of the step S9 is completed, the process returns to the step S3.

With reference to FIG. 11, in a step S11, the focus lens 12 is arranged in its initial position, the release amount of the aperture mechanism 14 is adjusted to its initial value, and the exposure time of the imaging surface is set to a reference value. Also in the step S11, a flag FLGwb referred to in the AWB process of a step S23 is set to “0”. Furthermore, the flag FLGwb is a flag for identifying the number of times to execute the arithmetic process according to the Equation 1 described above, and while showing “0” when the number of times of execution is 0, shows “1” when the number of times of execution is 1 or more.

In a step S13, it is repeatedly determined whether or not the vertical synchronization signal Vsync has been generated. When the determined result is updated from NO to YES, the process proceeds to a step S15 so as to take the 256 luminance evaluation values and the 256 AF evaluation values outputted from the AE/AF evaluation circuit 22. In a step S17, the AE process based on the taken luminance evaluation values is executed. As a result of this, a brightness of the through image is moderately adjusted.

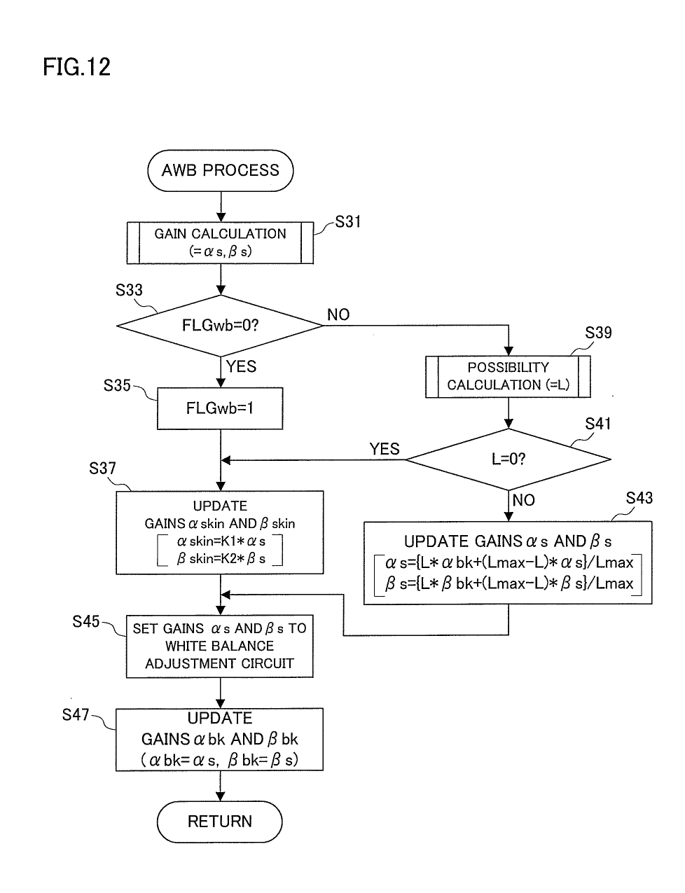

In a step S19, it is determined whether or not the AF activating condition is satisfied based on the AF evaluation values taken in the step S15. When the determined result is NO, the process proceeds to the step S23, and when the determined result is YES, the process proceeds to the step S23 after going through the AF process in a step S21. The AF process is executed based on the AF evaluation values taken in the step S15, and as a result of this, the sharpness of the through image is improved. In the step S23, the AWB process according to a subroutine shown in FIG. 12 through FIG. 14 is executed. As a result of this, the white balance of the through image is adjusted accurately. When the AWB process is completed, the process returns to the step S13.

With reference to FIG. 12, in a step S31, in order to calculate the optimum gains αs and βs, a gain calculation process is executed. The calculated optimum gains αs and βs are equivalent to gains for converting a color, which is obtained by mixing the R evaluation value Σr, the G evaluation value Σg, and the B evaluation value Σb belonging to at least one of the white detection ranges DT1 through DT3 by the additive color process, into the white color.

In a step S33, it is determined whether or not the flag FLGwb shows “0”. If the determined result is YES, in a step S35, the flag FLGwb is updated to “1”, and in a step S37, the gains αskin and βskin are set or updated. The skin color gain αskin shows a value which is K1 times the optimum gain αs, and the skin color gain βskin shows a value which is K2 times the optimum gain βs. Here, each of “K1” and “K2” is a constant, and the skin color gains αskin and βskin are equivalent to gains for converting the skin color into the white color.

If the determined result in the step S33 is NO, in a step 39, a possibility calculation process is executed. The possibility L calculated thereby is equivalent to the possibility of the object, having a color belonging to the white detection range, being a human skin. In a step S41, it is determined whether or not the calculated possibility L is “0”, and if the determined result is YES, in the step S37, the process updates the skin color gains αskin and βskin, yet if the determined result is NO, the process proceeds to a step S43.

In the step S43, the optimum gains αs and βs are corrected according to the Equation 4 described above. The optimum gains αs and βs come closer to the backup gains αbk and βbk (=the optimum gains αs and βs currently set to the resistor 52t) as the possibility L increases.

When the process of the step S37 or S43 is completed, the optimum gains αs and βs, set to the resistor 52t forming the white balance adjustment circuit 52, are updated. When the process transitions from the step S37 to a step S45, the optimum gains αs and his calculated in the step S31 are set to the resistor 52t. On the other hand, when the process transitions from the step S43 to the step S45, the optimum gains αs and βs corrected in the step S43 are set to the resistor 52t.

In a step S47, the backup gains αbk and βbk are updated by the optimum gains αs and βs set to the resistor 52t. As a result of this, the backup gains αbk and βbk at all times match the optimum gains αs and βs set to the resistor 52t, respectively. When the process of the step S47 is completed, the process returns to the routine of the upper hierarchical level.

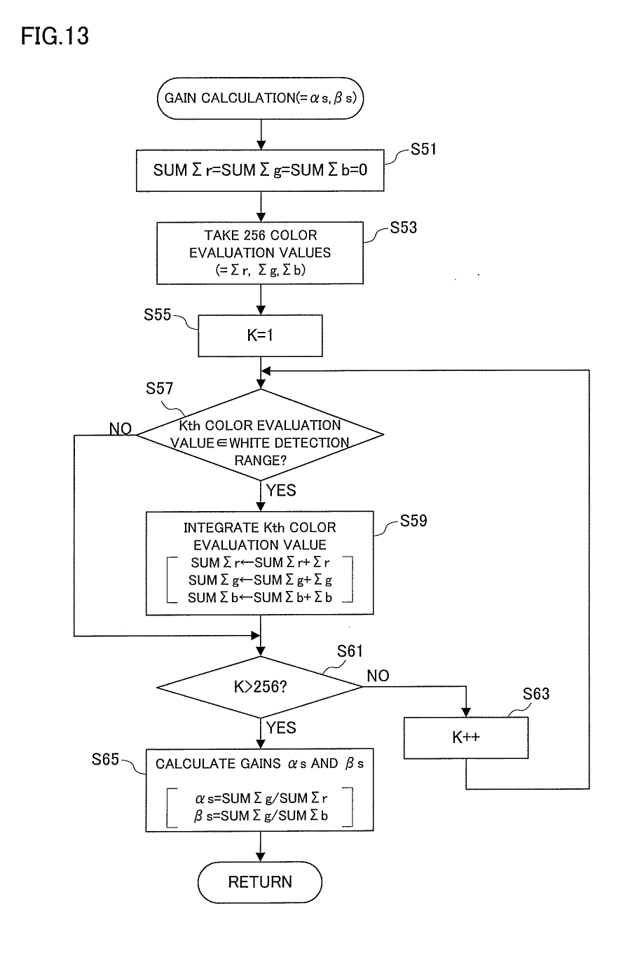

The gain calculation process of the step S31 is executed according to a subroutine shown in FIG. 13. First, in a step S51, the total sums SUMΣr, SUMΣg, and SUMΣb are set to “0”. In a step S53, the 256 R evaluation values Σr, Σr, . . . are taken from the integrator 56r, the 256 G evaluation values Σg, Σg, . . . are taken from the integrator 56g, and the 256 B evaluation values Σb, Σb, . . . are taken from the integrator 56b.

In a step S55, the variable K is set to “1”, and in a step S57, it is determined whether or not the color, defined by the R evaluation value Σr, the G evaluation value Σg, and the B evaluation value Σb corresponding to the K-th divided area, belongs to at least one of the white detection ranges DT1 through DT3. If the determined result is NO, the process proceeds to a step S61, and if the determined result is YES, the process proceeds to the step S61 after going through the process of a step S59. In the step S59, the K-th R evaluation value Σr is added to the total sum SUMΣr, the K-th G evaluation value Σg is added to the total sum SUMΣg, and the K-th B evaluation value Σb is added to the total sum SUMΣb.

In the step S61, it is determined whether or not the variable K exceeds “256”, and if the determined result is NO, in a step S63, the process increments the variable K, and then, returns to the step S57, yet if the determined result is YES, in a step S65, the process calculates the optimum gains αs and βs according to the Equation 1 described above. When the process of the step S65 is completed, the process returns to the routine of the upper hierarchical level.

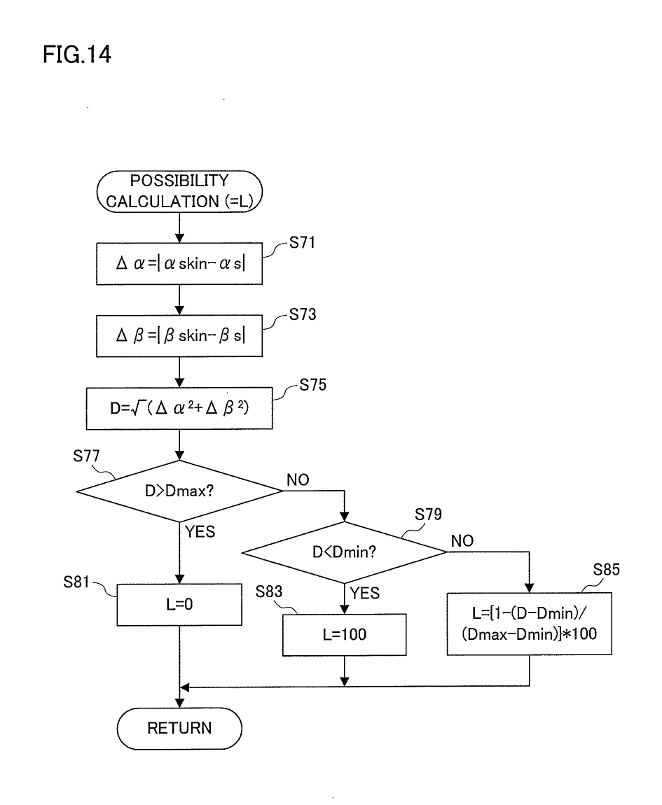

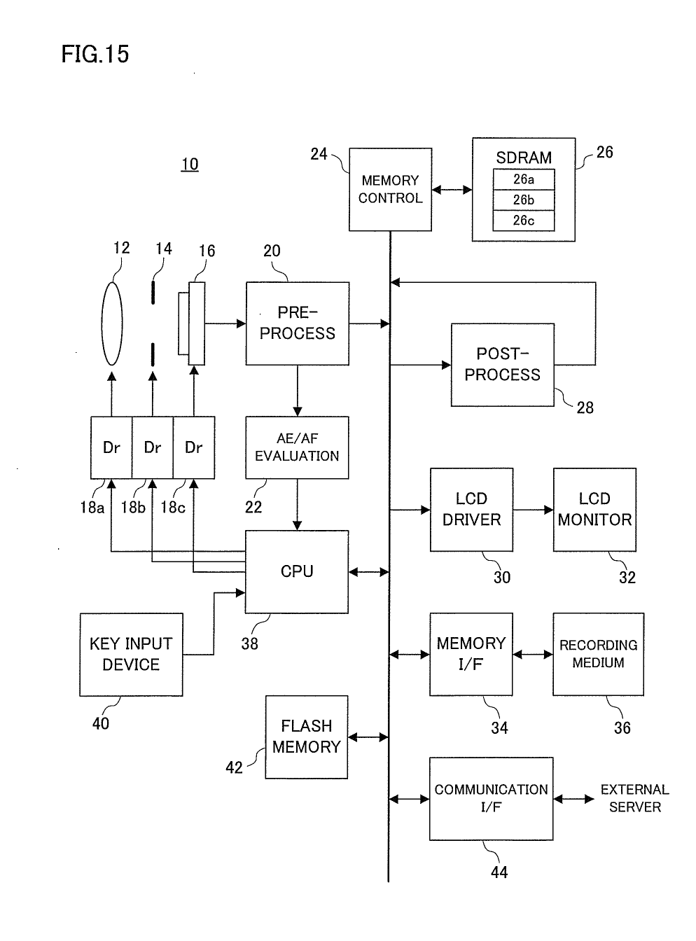

The possibility calculation process of the step S39 shown in FIG. 12 is executed according to a subroutine shown in FIG. 14.

In a step S71, the absolute value of the difference between the skin color gain αskin and the optimum gain αs is calculated as “Δα”. In a step S73, the absolute value of the difference between the skin color gain βskin and the optimum gain βs is calculated as “Δβ”. In a step S75, according to the Equation 2 described above, the distance from the coordinates (αskin, βskin) to the coordinates (αs, βs) is calculated as “D”. In a step S77, it is determined whether or not the calculated distance D exceeds the maximum value Dmax, and in a step S79, it is determined whether or not the calculated distance D falls below the minimum value Dmin. If the determined result of the step S77 is YES, the process proceeds to a step S81 so as to set the possibility L to “0”. If the determined result of the step S79 is YES, the process proceeds to a step S83 so as to set the possibility L to “100”. If both of the determined result of the step S77 and the determined result of the step S79 are NO, then, in a step S85, the possibility L is calculated according to the above-described Equation 3 described above. When the process of the step S81, S83, or step S85 is completed, the process returns to the routine of the upper hierarchical level.

As can be understood from the above description, the white balance adjustment circuit 52 adjusts the white balance of the image data that is repeatedly outputted from the color separation circuit 50 with reference to the optimum gains αs and βs set to the resistor 52t. The CPU 38 calculates the optimum gains αs and βs (S31), based on the partial image data indicating colors belonging to the white detection ranges DT1 through DT3, out of the image data outputted from the white balance adjustment circuit 52. Also, the CPU 38 detects the possibility that this partial image data is image data expressing the human skin, based on the calculated optimum gains αs and βs. The calculated values of the optimum gains αs and βs are brought closer to the backup gains αbk and βbk (=the optimum gains αs and βs currently set to the resistor 52t) along with the increase in the detected value of the possibility (S43). The optimum gains αs and βs showing values corrected in this way are set to the resistor 52t, and also withdrawn as the backup gains αbk and βbk (S45, S47).

The optimum gains αs and βs are calculated based on the partial image data showing colors belonging to the white detection ranges DT1 through DT3, and the possibility that this partial image data is image data representing the human skin is detected based on the calculated optimum gains αs and βs. The values of the optimum gains αs and βs are brought closer to the optimum gains αs and βs already set to the resistor 52t (that is, the previous optimum gains αs and βs) as the value of the detected possibility increases. The optimum gains αs and βs set to the resistor 52t are updated by the optimum gains αs and βs corrected in this way, and the white balance of the scene image repeatedly taken is adjusted with reference to the updated optimum gains αs and βs. Due to this, fluctuations in the white balance caused by the appearance of a human skin can be suppressed, and the performance of white balance adjustment is improved.

Furthermore, in this embodiment, the multi-task OS and the control program equivalent to the plurality of tasks executed by this are stored in advance on the flash memory 42. However, as shown in FIG. 15, by providing a communication I/F 44 on the digital camera 10, while preparing one part of the control program on the flash memory 42 from the beginning as an internal control program, other parts of the control program may be obtained from an external server as an external control program. In this case, the above-described operations are implemented by the cooperation of the internal control program and the external control program.

Also, in this embodiment, the processes executed by the CPU 38 are divided into a plurality of tasks in the manner described above. However, each of the tasks may be further divided into a plurality of smaller tasks, and furthermore, one portion of the plurality of the divided smaller tasks may be integrated with other tasks. Also, in a case of dividing each of the tasks into a plurality of smaller tasks, all or one portion of these may be obtained from an external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
a taker which repeatedly takes an image that expresses an imaged scene;
an adjuster which adjusts a white balance of the image taken by said taker with reference to a confirmed white balance adjustment coefficient;
a calculator which calculates an appropriate white balance adjustment coefficient based on a partial image indicating colors in a color range that includes a white color, out of the image taken by said taker;
a detector which detects a possibility that the partial image focused on by said calculator is an image expressing a human skin, based on the appropriate white balance adjustment coefficient calculated by said calculator;
a corrector which brings a value of the appropriate white balance adjustment coefficient calculated by said calculator closer to a value of the confirmed white balance adjustment coefficient, along with an increase of the value of the possibility detected by said detector; and
an updater which updates the confirmed white balance adjustment coefficient by the appropriate white balance adjustment coefficient which indicates the value corrected by said corrector.

2. An image processing apparatus according to claim 1, wherein said calculator includes a color evaluation value obtainer which obtains a plurality of color evaluation values respectively corresponding to a plurality of positions on the image taken by said taker, a color evaluation value extractor which extracts one or at least two color evaluation values belonging to the color range, from among the plurality of color evaluation values obtained by said color evaluation value obtainer, and an adjustment coefficient calculator which calculates the appropriate white balance adjustment coefficient based on the one or at least two color evaluation values extracted by said color evaluation value extractor.

3. An image processing apparatus according to claim 1, wherein the detector includes a difference calculator which calculates a difference between the appropriate white balance adjustment coefficient and a reference white balance adjustment coefficient corresponding to the skin color, and a controller which increases a value of the possibility as the difference calculated by said difference calculator decreases.

4. An image processing apparatus according to claim 3, further comprising a modifier which modifies the reference white balance adjustment coefficient based on the appropriate white balance adjustment coefficient calculated by said calculator, when the possibility detected by said detector is equal to or less than a threshold value.

5. An image processing apparatus according to claim 3, wherein the appropriate white balance adjustment coefficient is equivalent to a coefficient for converting the color, which is obtained by mixing colors of the partial image by an additive color process, into the white color, and the reference white balance adjustment coefficient is equivalent to a coefficient for converting the skin color into the white color.

6. An image processing apparatus according to claim 1, wherein the value corrected by the corrector is equivalent to a value obtained by additionally weighting, by a ratio differing depending on the value of the possibility, the value of the appropriate white balance coefficient and the value of the confirmed white balance adjustment coefficient.

7. An image processing apparatus according to claim 1, wherein said taker includes an imager having an imaging surface which captures a scene and repeatedly outputting the image.

8. A white balance adjustment program recorded on a non-transitory recording medium in order to control an image processing apparatus provided with a taker which repeatedly takes an image that expresses an imaged scene and an adjustor which adjusts a white balance of the image taken by said taker with reference to a confirmed white balance adjustment coefficient, the program causing a processor of the image processing apparatus to perform the steps comprising:
a calculation step of calculating the appropriate white balance adjustment coefficient based on a partial image indicating colors in a color range including the white color, out of the image taken by said taker;
a detection step of detecting a possibility that the partial image focused on by said calculation step is an image expressing a human skin, based on the appropriate white balance adjustment coefficient calculated by said calculation step;
a correction step of bringing a value of the appropriate white balance adjustment coefficient, calculated by said calculation step, closer to the value of the confirmed white balance adjustment coefficient, along with an increase of a value of the possibility detected by said detection step; and
an updating step of updating the confirmed white balance adjustment coefficient by the appropriate white balance adjustment coefficient showing the value corrected by said correction step.

9. A white balance adjustment method, executed by an image processing apparatus provided with a taker which repeatedly takes a subject image and an adjustor which adjusts a white balance of the subject image taken by said taker with reference to a confirmed white balance adjustment coefficient, the image processing apparatus being caused to perform the steps comprising:
a calculation step of calculating an appropriate white balance adjustment coefficient based on a partial image indicating colors in a color range including a white color, out of the subject image taken by said taker;
a detection step of detecting a possibility that the partial image focused on by said calculation step is an image expressing a human skin, based on the appropriate white balance adjustment coefficient calculated by said calculation step;
a correction step of bringing a value of the appropriate white balance adjustment coefficient, calculated by said calculation step, closer to the value of the confirmed white balance adjustment coefficient, along with an increase of a value of the possibility detected by said detection step; and
an updating step of updating the confirmed white balance adjustment coefficient by the appropriate white balance adjustment coefficient showing the value corrected by said correction step.
